(19) United States
(12) Patent Application Publication
(10) Pub. No.: US 2003/0086170 A1
(43) Pub. Date: May 8, 2003

(54) Polarizing plate and a liquid crystal display using the same

(76) Inventors: Eiji Hamamoto, Osaka (JP); Youichirou Sugino, Osaka (JP); Kazuki Tsuchimoto, Osaka (JP); Senri Kondou, Osaka (JP); Seiichi Kusumoto, Osaka (JP)

Correspondence Address: ARMSTRONG,WESTERMAN & HATTORI, LLP, 1725 K STREET, NW, SUITE 1000, WASHINGTON, DC, 20006, US

(21) Appl. No.: 09/970,444

(22) Filed: Oct. 3, 2001

(51) Int. Cl. G02F 1/1335; G02B 5/30; G02B 27/28

(52) U.S. Cl. 359/491; 359/483; 359/490; 349/96; 349/97

(57) ABSTRACT

A polarizing plate for a liquid crystal display and a liquid crystal display comprising the polarizing plate are provided. The polarizing plate having decreased display irregularity is produced by dyeing and crosslinking a polyvinyl alcohol (PVA) film so that it has

a (single transmittance)/(crossed transmittance)>600 when a wavelength is 440 nm;

a (single transmittance)/(crossed transmittance)>3000 when a wavelength is 550 nm; and

a (single transmittance)/(crossed transmittance)>11000 when a wavelength is 610 nm,

in which the single transmittance denotes optical transmittance of one polarizing plate and the crossed transmittance denotes optical transmittance of two polarizing plates arranged so that the polarizing axes cross at right angles.

### BACKGROUND OF THE INVENTION

1. Field of the Invention

The present invention relates to a liquid crystal display (LCD) that is improved to decrease irregularity in the display, and the present invention relates to a liquid crystal display comprising the polarizing plate.

2. Description of the Related Art

Polarizing plates used for display devices (specifically LCDs) are typically produced from polyvinyl alcohol (PVA) films or the like. The PVA films are dyed with dichroic iodine or dichroic dyestuff, crosslinked with boric acid or borax, and stretched uniaxially. The respective steps of dyeing, crosslinking and stretching can be carried out separately or simultaneously. There is no specific limitation on the order of the respective steps. Later, the films are dried and to which protective layers such as triacetylcellulose (TAC) films are bonded.

Use of LCDs in personal computers (PCs) has been increased sharply, and they have been used for monitors as well. LCD screens for monitors are larger and the panels are brighter (brightness is increased) when compared to screens for PCs. When a polarizing plate designed for a PC is used for a monitor, problems will occur in the display. For example, in a display of black or neutral colors such as gray, color irregularity of the polarizing plate or irregularity in phase contrast of PVA of the polarizing plate are recognized in the stretch axis direction when viewing the display in an oblique direction

### SUMMARY OF THE INVENTION

The present invention relates to a polarizing plate improved to decrease irregularity in the display and a liquid crystal display (LCD) using the polarizing plate.

In one embodiment of the present invention, a polarizing plate is produced by dyeing and crosslinking a polyvinyl alcohol (PVA) film, and the polarizing plate has

a (single transmittance)/(crossed transmittance)>600 when a wavelength is 440 nm;

a (single transmittance)/(crossed transmittance)>3000 when a wavelength is 550 nm; and

a (single transmittance)/(crossed transmittance)>11000 when a wavelength is 610 nm

In this case, the single transmittance denotes optical transmittance of one polarizing plate and the crossed transmittance denotes optical transmittance of two polarizing plates arranged so that the polarizing axes cross at right angles.

In a preferred embodiment, the present invention satisfies the following relationships:

a parallel transmittance)/(crossed transmittance)>700 when a wavelength is 440 nm;

a parallel transmittance)/(crossed transmittance)>3000 when a wavelength is 550 nm; and

a (parallel transmittance)/(crossed transmittance)>11000 when a wavelength is 610 nm.

In this case, the parallel transmittance denotes optical transmittance of two polarizing plates arranged so that the polarizing axes become parallel to each other, and the crossed transmittance denotes optical transmittance of two polarizing plates arranged so that the polarizing axes cross at right angles.

It is preferable in the present invention that a luminous corrected transmittance Y calculated in accordance with the method of JIS Z 87012 degree visual field XYZ system is at least 42.5% when the standard illuminant is a C light source having luminous factor correction per 10 nm in a range from 700 to 400 nm. More preferably, the transmittance Y is at least 43.0% but mot more than 44.0%.

It is preferable in the present invention that the polarization degree of the polarizing plate is at least 99.98%.

In one embodiment, a polarizing plate of the present invention is produced from a polyvinyl alcohol (PVA) film by:

dyeing the PVA film in a dye bath containing a dye selected from the group consisting of dichroic iodine and dichroic dyestuff, and crosslinking in at least two crosslinking baths containing a crosslinking agent while stretching the PVA film in the respective crosslinking steps, in which a stretch ratio in a first crosslinking bath is 1-4, and a stretch ratio in a second crosslinking bath is higher than the stretch ratio in the first bath. Preferably in this case, the total stretch ratio for the PVA film ranges from 5 to 7.

In one embodiment, the polarizing plate according to the present invention can be either a reflective or a semitransparent reflective polarizing plate obtained by bonding either a reflecting plate or a semitransparent reflecting plate to any of the above-mentioned polarizing plates.

In one embodiment, the polarizing plate according to the present invention can be obtained by bonding a retardation plate (λ plate) to any of the abovementioned polarizing plates.

In one embodiment, the polarizing plate according to the present invention can be obtained by bonding a viewing angle compensating film to any of the abovementioned polarizing plates.

In one embodiment, the polarizing plate according to the present invention can be obtained by bonding a brightness-enhanced film to any of the above-mentioned polarizing plates by using an adhesive or a pressure-sensitive adhesive.

### DETAILED DESCRIPTION OF THE INVENTION

A typical process of producing a polarizing film comprises three steps of dyeing, crosslinking and stretching. In a dyeing step, a PVA film is dyed in a bath containing a dichroic iodine or dyestuff. In a crosslinking step, the film is crosslinked in a bath containing a PVA-crosslinking agent such as boric acid and borax. In a stretching step, the PVA film is stretched.

Stretching is often performed simultaneously with the dyeing and crosslinking steps, but it can be carried out separately. Alternatively, the dyeing step and the crosslinking step can be performed at the same time. Subsequent to the three steps, the PVA film is dried and bonded to a protective layer such as a TAC (triacetylcellulose) film so as to provide a polarizing film.

There is no specific limitation on a method of producing a polarizing plate according to the present invention, though it is preferable to produce a polarizing film by stretching during the dyeing and crosslinking steps. A polarizing plate having the above characteristics can be obtained easily by using at least two baths containing a crosslinking agent in the crosslinking step. In one embodiment, the film is stretched in the first bath containing a crosslinking agent at a ratio ranging from 1 to 4, then the film is stretched in the following bath(s) containing a crosslinking agent at a stretch ratio higher than that of the first bath. It is preferable that the total stretch ratio for the PVA film ranges from 5 to 7.

In one embodiment, a polarizing plate of the present invention has a basic structure comprising a polarizer of e.g., a polyvinyl alcohol-based polarizing film containing a dichroic substance, and a transparent protective film as a protective layer adhered to at least one surface of the polarizer through a suitable adhesive layer comprising, for example, a vinyl alcohol-based polymer.

In one embodiment, a polarizer (polarizing film) is prepared from a conventional film comprising a suitable vinyl alcohol-based polymer such as polyvinyl alcohol and partially formalized polyvinyl alcohol. The film is treated in a suitable order and a suitable process, for example, dyeing with a dichroic substance selected from, e.g., iodine and dichroic dyestuff, stretching and crosslinking. A preferable polarizer will transmit linearly polarized light when natural light enters. It is more preferable that the polarizer has excellent optical transmittance and polarization degree.

Any appropriate transparent film can be used for a protective film to form a transparent protective layer on at least one surface of a polarizer (polarizing film). One typical and non-limitative example of polymers for the protective film is acetate-based resin such as triacetylcellulose.

A transparent protective film preferred especially from the aspect of polarizing characteristics and durability is a triacetylcellulose film having a surface saponified with an alkali substance or the like. Transparent protective films formed on both surfaces of a polarizing film are not necessarily made of identical polymers.

A transparent protective film used for the protective layer can be treated to provide properties such as hard coating, antireflection, anti-sticking, diffusion and anti-glaring, as long as the purposes of the present invention are not sacrificed. Hard coating treatment is applied, for example, to prevent scratches on the surfaces of the polarizing plate. A surface of the transparent protective film can be applied with a coating film of a cured resin with excellent hardness and smoothness, e.g., a silicone-based ultraviolet-cure type resin.

Antireflection treatment may be applied to prevent reflection of outdoor daylight on the surface of the polarizing plate. Such an anti-reflection film or the like can be formed in a known method. Anti-sticking treatment is applied to prevent adherence of adjacent layers. Anti-glaring treatment is applied to prevent visibility of light transmitted through the polarizing plate from being hindered by outdoor daylight reflected on the polarizing plate surface. Anti-glare treatment can be carried out by providing microscopic asperity on a surface of a transparent protective film in an appropriate manner, e.g., by roughening the surface by sand-blasting or embossing, or by blending transparent particles.

The above-mentioned transparent fine particles will be selected from silica, alumina, titania, zirconia, stannic oxide, indium oxide, cadmium oxide, antimony oxide or the like, and the particles have an average diameter ranging from 0.5 μm to 20 μm. Inorganic fine particles having electroconductivity can be used as well. Alternatively, the particles can be organic fine particles comprising, for example, crosslinked or uncrosslinked polymer particles. An amount of the transparent fine particles ranges from 2 weight parts to 70 weight parts, and generally, from 5 weight parts to 50 weight parts, for 100 weight parts of a transparent resin.

An anti-glare layer comprising transparent fine particles can be provided as the if transparent protective layer or a coating layer applied onto a transparent protective layer surface. The anti-glare layer can function as a diffusion layer to diffuse light transmitted through the polarizing plate in order to enlarge visual angles (this function is denoted as visual angle compensation). The above-mentioned layers such as the antireflection layer, the anti-sticking layer, the diffusion layer and the anti-glare layer can be provided as an sheet of optical layers comprising these layers separately from the transparent protective layer.

There is no specific limitation on treatment to adhere the polarizer (polarizing film) and the transparent protective film. Adhesion can be applied, for example, by using adhesives such as an adhesive comprising vinyl alcohol-based polymer, or an adhesive comprising at least the vinyl alcohol-based polymer and a water-soluble agent to crosslink the vinyl alcohol-based polymer, such as boric acid, borax, glutaraldehyde, melamine and oxalic acid. Such an adhesive layer is formed by, for example, applying and drying an aqueous solution, and an additive or a catalyst such as an acid can be blended in preparation of the aqueous solution if required.

A polarizing plate of the present invention can be laminated with another optical layer in order to be used as an optical member. Though there is no specific limitation on the optical layer, one or more suitable optical layer applicable for formation of a liquid crystal display can be used, and the optical layer can be selected from, for example, a reflecting plate, a semitransparent reflecting plate, a retardation plate such as a λ plate like a half wavelength plate and a quarter wavelength plate, a viewing angle compensating film, and a brightness-enhanced film. In a preferred embodiment, a reflective polarizing plate or a semitransparent reflective polarizing plate formed by laminating an additional reflecting plate or a semitransparent reflecting plate on the above-mentioned polarizing plate comprising a polarizer and a protective layer according to the present invention; a polarizing plate formed by laminating an additional retardation plate on the above-mentioned polarizing plate comprising a polarizer and a protective layer; a polarizing plate having a viewing angle compensating film laminated additionally on the above-mentioned polarizing plate comprising a polarizer and a protective layer; and a polarizing plate having a brightness-enhanced film laminated additionally on the above-mentioned polarizing plate comprising a polarizer and a protective layer is used.

A reflecting plate is provided to a polarizing plate in order to form a reflective polarizing plate. In general, such a reflective polarizing plate is arranged on a backside of a liquid crystal cell in order to make a liquid crystal display to reflect incident light from a visible side (display side). The reflective polarizing plate has some merits, for example, assembling of light sources such as backlight can be omitted, and the liquid crystal display can be thinned further.

The reflective polarizing plate can be formed in an appropriate manner such as attaching a reflecting layer of metal or the like on one surface of the polarizing plate. For example, a transparent protective film is prepared by matting one of the surfaces if required. On this surface, a foil comprising a reflective metal such as aluminum or a deposition film is applied to form a reflecting layer.

An additional example of a reflective polarizing plate comprises the above-mentioned transparent protective film having a sure of a microscopic asperity due to contained fine particles, and also a reflecting layer corresponding to the microscopic asperity. The reflecting layer having a microscopic asperity surface diffuses incident light irregularly so that directivity and glare can be prevented and irregularity in color tones can be controlled. This transparent protective film can be formed by attaching a metal directly on a surface of a transparent protective film in any appropriate methods including deposition such as vacuum deposition, and plating such as ion plating and sputtering.

Alternatively, the reflecting plate can be used as a reflecting sheet formed by providing a reflecting layer onto a proper film similar to the transparent protective film. Since a typical reflecting layer of a reflecting plate is made of a metal, it is used preferably in a state coated with a film, a polarizing plate or the like in order to prevent the reflection rate from reduction due to oxidation. As a result, the initial reflection rate is maintained for a long period, and a separate protective layer can be omitted.

A semitransparent polarizing plate is provided by replacing the reflecting layer in the above-mentioned reflective polarizing plate by a semitransparent reflecting layer, and it is exemplified by a half mirror that reflects and transmits light at the reflecting layer. In general, such a semitransparent polarizing plate is arranged on a backside of a liquid crystal cell. In a liquid crystal display comprising the semitransparent polarizing plate, incident light from the visible side (display side) is reflected to display an image when a liquid crystal display is used in a relatively bright atmosphere, while in a relatively dark atmosphere, an image is displayed by using a built-in light source such as a backlight in the backside of the semitransparent polarizing plate. In other words, the semitransparent polarizing plate can be used to form a liquid crystal display that can save energy for a light source such as a backlight under a bright atmosphere, while a built-in light source can be used under a relatively dark atmosphere.

The above-mentioned polarizing plate comprising a polarizer and a protective layer can have an additional laminate of a retardation plate.

The retardation plate is used for modifying linearly polarized light to either elliptically polarized light or circularly polarized light, modifying either elliptically polarized light or circularly polarized light to linearly polarized light, or modifying a polarization direction of linearly polarized light. For example, a retardation plate called a quarter wavelength plate (λ/4 plate) is used for modifying linearly polarized light to either elliptically polarized light or circularly polarized light, and for modifying either elliptically polarized light or circularly polarized light to linearly polarized fight. A half wavelength plate (λ/2 plate) is used in general for modifying a polarization direction of linearly polarized light.

The abovedescribed elliptical polarizing plate is effective in compensating (preventing) colors (blue or yellow) generated due to birefringence in a liquid crystal layer of a super twist nematic (STN) liquid crystal display so as to provide a black-and-white display free of such colors. Controlling three-dimensional refractive index is preferred further since it can compensate (prevent) colors that will be observed when looking a screen of the liquid crystal display from an oblique direction. A circular polarizing plate is effective in adjusting color tones of an image of a reflective liquid crystal display that has a color image display, and the polarizing plate serves to prevent reflection as well.

Specific examples of the retardation plates include birefringent films, oriented films of liquid crystal polymers, sheets comprising film and oriented layers supported by the films, and incline-oriented films. The birefringent films can be prepared by stretching films of any suitable liquid crystal polymers such as polycarbonate, polyvinyl alcohol, polystyrene, polymethyl methacrylate, polyolefins including polypropylene, polyalylate, and polyamide. An incline-oriented film is produced, for example, by bonding a heat shrinkable film onto a polymer film and stretching and/or shrinking the polymer film under an influence of the shrinking force provided by heat, or by orienting obliquely a liquid crystal polymer.

A polarizing plate described below comprises the above-mentioned polarizer and protective layer, and further an additional viewing angle compensating film laminated on the polarizing plate.

A viewing angle compensating film is used for widen an visual angle so that an image can be clear relatively when a screen of a liquid crystal display is seen not in a direction perpendicular to the screen but in a slightly oblique direction.

Such a viewing angle compensating film can be a triacetylcellulose film coated with a discotic liquid crystal, or a retardation plate. While an ordinary retardation plate is a birefringent polymer film that is stretched uniaxially in the face direction, a retardation plate used for an viewing angle compensating film is a two-way stretched film such as a birefringent polymer film stretched biaxially in the face direction and an incline-oriented polymer film with controlled birefringence in the thickness direction that is stretched uniaxially in the face direction and stretched also in the thickness direction. The incline-oriented film is prepared by, for example, bonding a heat shrinkable film to a polymer film and stretching and/or shrinking the polymer film under an influence of shrinkage force provided by heat, or by orienting obliquely a liquid crystal polymer. A polymer as a material of the retardation plate is similar to the polymer used for the above-mentioned retardation plate.

A polarizing plate described below is produced by laminating a brightness-enhanced film additionally on the above-mentioned polarizing plate comprising a polarizer and a protective layer. Generally, this polarizing plate is arranged on a backside of a liquid crystal cell. When natural light enters, by reflection from a backlight or a backside of a liquid crystal display etc., the brightness-enhanced film reflects linearly polarized light of a predetermined polarizing axis or circularly polarized light in a predetermined direction while the same film transmits other light. It allows entrance of light from a light source such as a backlight so as to obtain transmitted light in a predetermined polarization state, while reflecting light other than light in the predetermined polarization state. Light that is reflected at this brightness-enhanced film is reversed through a reflecting layer or the like arranged additionally behind the brightness-enhanced film. The reversed light that reenters the brightness-enhanced plate is transmitted partly or entirely as light in a predetermined polarization state, so that light transmitting the brightness-enhanced film is increased and polarized light that is hardly absorbed in the polarizer is supplied. As a result, quantity of light available for the liquid crystal display etc. can be increased to improve brightness. When light enters through a polarizer from the backside of a liquid crystal cell by using a backlight or the like without using any brightness-enhanced films, most light is absorbed in the polarizer but not transmitted the polarizer if the light has a polarization direction inconsistent with the polarization axis of the polarizer. Depending on characteristics of the polarizer, about 50% of light is absorbed in the polarizer, and this decreases quantity of light available in the liquid crystal display or the like and makes the image dark. The brightness-enhanced film repeatedly prevents light having a polarization direction to be absorbed in the polarizer from entering the polarizer, and reflects the light on the brightness-enhanced film, reverses the light through a reflecting layer or the like arranged behind, and makes the light reenter the brightness-enhanced plate. Since the polarized light that is reflected and reversed between them is transmitted only if the light has a polarization direction to pass the polarizer, light from a backlight or the like can be used efficiently for displaying images of a liquid crystal display in order to provide a bright screen.

A suitable example of the brightness-enhanced film is selected from a multilayer thin film of a dielectric or a multilayer lamination of thin films with varied refraction aeolotropy (e.g., “D-BEF” supplied by 3M Co.) that transmits linearly polarized light having a predetermined polarization axis while reflecting other light, and a cholesteric liquid crystal layer, more specifically, an oriented film of a cholesteric liquid crystal polymer or an oriented liquid crystal layer fixed onto a supportive substrate (e.g., “PCF 350” supplied by Nitto Denko Corporation; “Transmax” supplied by Merck and Co., Inc.) that reflects either clockwise or counterclockwise circularly polarized light while transmitting other light.

Therefore, for a brightness-enhanced film to transmit linearly polarized light having a predetermined polarization axis, the transmission light enters the polarizing plate by matching the polarization axis so that absorption loss due to the polarizing plate is controlled and the light can be transmitted efficiently. For a brightness-enhanced film to transmit circularly polarized light, i.e., a cholesteric liquid crystal layer, preferably, the transmission circularly polarized light is converted to linearly polarized light before entering the polarizing plate in an aspect of controlling of the absorption loss, though the circularly polarized light can enter the polarizer directly. Circularly polarized light can be converted to linearly polarized light by using a quarter wavelength plate for a retardation plate.

A retardation plate having a function as a quarter wavelength plate in a wide wave range including a visible light region can be obtained, for example, by overlapping a retardation layer functioning as a quarter wavelength plate for monochromatic light such as light having 550 nm wavelength and another retardation plate showing a separate optical retardation property (e.g., a retardation plate functioning as a half wavelength plate). Therefore, a retardation plate arranged between a polarizing plate and a brightness-enhanced film can comprise a single layer or at least two layers of retardation layers.

A cholesteric liquid crystal layer also can be provided by combining layers different in the reflection wavelength and it can be configured by overlapping two or at least three layers. As a result, the obtained retardation plate can reflect circularly polarized light in a wide wavelength range including a visible light region, and this can provide transmission circularly polarized light in a wide wavelength range.

A polarizing plate according to the present invention can be made by laminating a polarizing plate and two or at least tree optical layers, similarly to the above-described polarization-separation type polarizing plates. In other words, the polarizing plate can be a reflective polarizing plate or a semitransparent polarizing plate for elliptically polarized light, which is prepared by combining either the above-mentioned reflective polarizing plate or a semitransparent polarizing plate with a retardation plate. An optical member comprising a lamination of two or at least three optical layers can be formed in a method of laminating layers separately in a certain order for manufacturing a liquid crystal display etc. Since an optical member that has been laminated previously has excellent stability in quality and assembling operability, efficiency in manufacturing a liquid crystal display can be improved. Any appropriate adhesion means such as a pressure-sensitive adhesive can be used for laminating the polarizing plate and optical layers.

A pressure-sensitive adhesive layer can be provided to a polarizing plate or to an optical member in the present invention for adhesion with other members such as a liquid crystal cell. The pressure-sensitive adhesive layer can contain any suitable pressure-sensitive adhesives such as an acrylic adhesive in accordance with conventional techniques. Particularly, pressure-sensitive adhesive layers having a low moisture absorption coefficient and an excellent heat resistance is preferred from the aspect of prevention of foaming or peeling caused by moisture absorption or prevention of decrease in the optical properties and warping of a liquid crystal cell caused by difference in thermal expansion coefficients. As a result, a high quality liquid crystal display having excellent durability can be produced. The pressure-sensitive adhesive layer can include fine particles to obtain optical diffusivity. Pressure-sensitive adhesive layers can be provided to appropriate surfaces if required. For example, a polarizing plate comprising a polarizer and a protective layer can be provided with a pressure-sensitive adhesive layer on at least one surface of the protective layer.

When a pressure-sensitive adhesive layer is exposed on a surface of the polarizing plate or the optical member, preferably, the pressure-sensitive adhesive layer is covered with a separator by the time the pressure-sensitive adhesive layer is used so that contamination will be prevented. The separator can be made of an appropriate thin sheet by coating a peeling agent if required, and the peeling agent may be selected, for example, from a silicone-based agent, a long-chain alkyl-based agent, a fluorine-based agent, an agent comprising molybdenum sulfide or the like.

The above-described members composing a polarizing plate and an optical member, such as a polarizer, a transparent protective film, an optical layer and a pressure-sensitive adhesive layer, can have ultraviolet absorption power as a result of treatment with an ultraviolet absorber such as an ester salicylate compound, a benzophenone compound, a benzotriazole compound, a cyanoacrylate compound, and a nickel complex salt compound.

Polarizing plates according to the present invention can be used preferably for forming various devices such as LCDs. Such a polarizing plate is arranged on at least one surface of a liquid crystal cell in order to form various devices such as a liquid crystal display. The liquid crystal display is selected from devices of conventionally known structures, such as transmission type, reflection type, or a transmission-reflection type. A liquid crystal cell to compose the liquid crystal display can be selected from appropriate cells of such as active matrix driving type represented by a thin film transistor, a simple matrix driving type represented by a twist nematic type and a super twist nematic type.

When polarizing plates or optical members are arranged on both surfaces of a liquid crystal cell, the polarizing plates or the optical members on the surfaces can be the same or can be varied. Moreover, for forming a liquid crystal display, one or at least two layers of appropriate members such as a prism array sheet, a lens array sheet, an optical diffuser and a backlight can be arranged at proper positions.

The present invention provides a polarizing plate that will have substantially no irregularity even when the polarizing plate is used in a LCD for a high-intensity monitor or the like.

The present invention will be described below more specifically by referring to Examples.

### COMPARATIVE EXAMPLE 1

A polarizer was produced by dyeing a PVA film supplied by Kuraray Co., Ltd. (9×75RS) in a dye bath (an aqueous solution containing iodine and KI) while stretching to 3.2 times, further stretching the film to 1.9 times in a crosslinking bath containing boric acid (total stretch ratio was 6.08), and drying the film in a 50° C. dryer. Later, the polarizer was bonded to a TAC film by means of a PVA-based adhesive. The thus obtained polarizing plate had a luminous corrected transmittance of 44.13% and a polarization degree of 99.94%.

### COMPARATIVE EXAMPLE 2

A polarizer was produced by dyeing a PVA film supplied by Kuraray Co., Ltd. (9×75RS) in a dye bath (an aqueous solution containing iodine and KI) while stretching to 3 times, further stretching to 1.5 times in a first crosslinking bath containing boric acid and subsequently to 1.34 times in a second crosslinking bath containing boric acid (total stretch ratio was 6.03), and drying the film in a 50° C. dryer. Later, the polarizer was bonded to a TAC film by means of a PVA-based adhesive. The thus obtained polarizing plate had a luminous corrected transmittance of 43.35% and a polarization degree of 99.97%.

### EXAMPLE 1

A polarizer was produced by dyeing a PVA film supplied by Kuraray Co., Ltd. (9×75RS) in a dye bath (an aqueous solution containing iodine and KI) while stretching to 3.2 times, further stretching to 1.2 times in a first crosslinking bath containing boric acid and subsequently to 1.7 times in a second crosslinking bath containing boric acid (total stretch ratio was 6.5), and drying the film in a 50° C. dryer. Later, the polarizer was bonded to a TAC film by means of a PVA-based adhesive. The thus obtained polarizing plate had a luminous corrected transmittance of 43.25% and a polarization degree of 99.98%.

### EXAMPLE 2

A polarizer was produced by dyeing a PVA film supplied by Kuraray Co., Ltd. (9×75RS) in a dye bath (an aqueous solution containing iodine and KI) while stretching to 3 times, further stretching to 1.4 times in a first crosslinking bath containing boric acid and subsequently to 1.6 times in a second crosslinking bath containing boric acid (total stretch ratio was 6.72), and drying the film in a 50° C. dryer. Later, the polarizer was bonded to a TAC film by means of a PVA-based adhesive. The thus obtained polarizing plate had a luminous corrected transmittance of 43.35% and a polarization degree of 99.99%.

Transmittance of each polarizing plate was measured by means of an instrument for integrating-sphere spectral transmittance (DO-3 supplied by MURAKAMI COLOR RESEARCH LABATORY).

(First Evaluation of Polarizing Plate Irregularity)

Two polarizing plates to be evaluated were disposed on a backlight having an illumination of 33000 lux in a darkroom so that the polarizing axes would cross at right angles in order to check whether stripe-shaped irregularity would be recognized visually in a direction perpendicular to the polarizing axes.

(Second Evaluation of Polarizing Plate Irregularity)

Two polarizing plates were arranged on a backlight having an illumination of 33000 lux in a darkroom in a state that the polarization axes would be parallel to each other, and a third polarizing plate to be evaluated was disposed between the two polarizing plates at a right angle so as to check whether irregularity of the polarizing plates would be recognized in a direction perpendicular to the polarizing axis of the third polarizing plate.

(Third Evaluation of Polarizing Plate Irregularity)

A commercially available LCS monitor (18.1 inches, 300 candelas) comprising a liquid crystal cell with top and bottom polarizing plates was prepared. The polarizing plates were peeled from the liquid crystal cell, and polarizing plates to be evaluated are bonded to the liquid crystal cell as replacements by means of a pressure-sensitive adhesive. Then, the monitor was switched to black display to check whether stripe-shaped irregularity would be recognized in a direction perpendicular to the polarizing axes of the polarizing plates by varying the viewing angles.

TABLE 1

| | Transmittance in a wavelength of 440 nm (%) | | | | |
|---|---|---|---|---|---|
| | Single transmittance (A) | Parallel transmittance (B) | Crossed transmittance (C) | (A)/(C) | (B)/(C) |
| Com. Ex. 1 | 40.240 | 32.150 | 0.109 | 369 | 295 |
| Com. Ex. 2 | 39.425 | 31.030 | 0.071 | 555 | 437 |
| Example 1 | 39.210 | 30.580 | 0.017 | 2306 | 1799 |
| Example 2 | 39.460 | 30.850 | 0.018 | 2192 | 1714 |

TABLE 2

| | Transmittance in a wavelength of 550 nm (%) | | | | |
|---|---|---|---|---|---|
| | Single transmittance (A) | Parallel transmittance (B) | Crossed transmittance (C) | (A)/(C) | (B)/(C) |
| Com. Ex. 1 | 44.280 | 38.820 | 0.026 | 1703 | 1493 |
| Com. Ex. 2 | 43.510 | 37.570 | 0.014 | 3108 | 2684 |
| Example 1 | 43.430 | 37.310 | 0.011 | 3948 | 3392 |
| Example 2 | 43.530 | 37.390 | 0.001 | 43530 | 37390 |

TABLE 3

| | Transmittance in a wavelength of 610 nm (%) | | | | |
|---|---|---|---|---|---|
| | Single | Parallel | Crossed | | |
| | transmittance | transmittance | transmittance | | |
| | (A) | (B) | (C) | (A)/(C) | (B)/(C) |
| Com. | 44.380 | 39.050 | 0.004 | 11095 | 9763 |
| Ex. 1 | | | | | |
| Com. | 43.430 | 37.470 | 0.002 | 21715 | 18735 |
| Ex. 2 | | | | | |
| Example 1 | 43.500 | 37.510 | 0.003 | 14500 | 12503 |
| Example 2 | 43.520 | 37.490 | 0.002 | 21760 | 18745 |

TABLE 4

| | Evaluation for irregularity | | |
|---|---|---|---|
| | Evaluation 1 | Evaluation 2 | Evaluation 3 |
| | (visual check) | (visual check) | (visual check) |
| Com. Ex. 1 | B | B | B |
| Com. Ex. 2 | B | B | B |
| Example 1 | A | A | A |
| Example 2 | A | A | A |

*A: irregularity was not recognized
B: irregularity was recognized

(Evaluation Results)

As indicated in the evaluation results of Tables 1-4, high quality polarizing plates having substantially no visible irregularity were obtained in Examples 1 and 2.

In other words, excellent polarizing plates having no visible irregularity were obtained by adjusting stretch ratios in a first and second baths containing boric acid and also the total stretch ratio, and by setting the transmittance substantially within arrange from 43.2% to 43.3% to make the polarization degree to be at least 99.98%.

As mentioned above, the present invention provides a polarizing plate for a liquid crystal display and a liquid crystal display comprising the polarizing plate. The polarizing plate improved to decrease display irregularity is produced by dyeing and crosslinking a polyvinyl alcohol (PVA) film so that it has

a (single transmittance)/(crossed transmittance)>600 when a wavelength is 440 nm;

a (single transmittance)/(crossed transmittance)>3000 when a wavelength is 550 nm; and

a (single transmittance)/(crossed transmittance)>11000 when a wavelength is 610 nm.

In this case, the single transmittance denotes optical transmittance of one polarizing plate and the crossed transmittance denotes optical transmittance of two polarizing plates arranged so that the polarizing axes cross at right angles.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, all changes that come within the meaning and range of equivalency of the claims are intended to be embraced therein.

What is claimed is:

1. A polarizing plate having
a (single transmittance)/(crossed transmittance)>600 when a wavelength is 440 nm;
a (single transmittance)/(crossed transmittance)>3000 when a wavelength is 550 nm, and
a (single transmittance)/(crossed transmittance)>11000 when a wavelength is 610 nm,
where single transmittance denotes optical transmittance of one polarizing plate and crossed transmittance denotes optical transmittance of two polarizing plates arranged so that the polarizing axes cross at right angles.

2. The polarizing plate according to claim 1, wherein the polarizing plate has
a parallel transmittance)/(crossed transmittance)>700 when a wavelength is 440 nm;
a (parallel transmittance)/(crossed transmittance)>3000 when a wavelength is 550 nm; and
a (parallel transmittance)/(crossed transmittance)>11000 when a wavelength is 610 nm,
where parallel transmittance denotes optical transmittance of two polarizing plates arranged so that the polarizing axes become parallel to each other, and crossed transmittance denotes optical transmittance of two polarizing plates arranged so that the polarizing axes cross at right angles.

3. The polarizing plate according to claim 1, wherein a luminous corrected transmittance Y is at least 42.5% when the standard illuminant is a C light source having luminous factor correction per 10 nm in arrange from 700 nm to 400 nm.

4. The polarizing plate according to claim 1, wherein the transmittance Y is at least 43.0% but not more than 44.0%.

5. The polarizing plate according to claim 1, wherein the polarization degree is at least 99.98%.

6. The polarizing plate according to claim 1, produced from a polyvinyl alcohol (PVA) film in a series of steps of:
dyeing the PVA film in a dye bath containing a dye selected from the group consisting of dichroic iodine and dichroic dyestuff, and crosslinking in at least two crosslinking baths containing a crosslinking agent while stretching the PVA film in the respective crosslinking steps, in which a stretch ratio in a first crosslinking bath is 1-4, and a stretch ratio in a second crosslinking bath is higher than the stretch ratio in the first bath.

7. The polarizing plate according to claim 6, wherein a total stretch ratio for the PVA film ranges from 5 to 7.

8. The polarizing plate according to claim 1, further comprising either a reflecting plate or a semitransparent reflecting plate bonded to the polarizing plate.

9. The polarizing plate according to claim 1, further comprising a retardation plate (λ plate) bonded to the polarizing plate.

10. The polarizing plate according to claim 1, further comprising a viewing angle compensating film bonded to the polarizing plate.

11. The polarizing plate according to claim 1, further comprising a brightness-enhanced film bonded to the polarizing plate by means of either an adhesive or pressure-sensitive adhesive.

12. A liquid crystal display comprising a liquid crystal cell and a polarizing plate provided onto at least one surface of the liquid cry cell
wherein the polarizing plate obtained from a polyvinyl alcohol (PVA) film has
a (single transmittance)/(crossed transmittance)>600 when a wavelength is 440 nm;
a (single transmittance)/(crossed transmittance)>3000 when a wavelength is 550 nm; and
a (single transmittance)/(crossed transmittance)>11000 when a wavelength is 610 nm;
where single transmittance denotes optical transmittance of one polarizing plate and crossed transmittance denotes optical transmittance of two polarizing plates arranged so that the polarizing axes cross at right angles.

13. A method of producing a polarizing plate, comprising:
dyeing a PVA film in a dye bath containing a dye selected from the group consisting of dichroic iodine and dichroic dyestuff, and crosslinking in at least two crosslinking baths containing a crosslinking agent while stretching the PVA film in the respective crosslinking steps, in which a stretch ratio in a first crosslinking bath is 1-4 and a stretch ratio in a second crosslinking bath is higher than the stretch ratio in the first bath;
the polarizing plate having
a (single transmittance)/(crossed transmittance)>600 when a wavelength is 440 nm;
a (single transmittance)/(crossed transmittance)>3000 when a wavelength is 550 nm; and
a (single transmittance)/(crossed transmittance)>11000 when a wavelength is 610 nm;
where single transmittance denotes optical transmittance of one polarizing plate and crossed transmittance denotes optical transmittance of two polarizing plates arranged so that the polarizing axes cross at right angles.

14. The method according to claim 13, wherein the crosslinking agent is boric acid.

15. The method according to claim 13, wherein a total stretch ratio for the PVA film ranges from 5 to 7.

16. The method according to claim 13, wherein the polarizing plate has
a (parallel transmittance)/(crossed transmittance)>700 when a wavelength is 440 nm;
a (parallel transmittance)/(crossed transmittance)>3000 when a wavelength is 550 nm; and
a (parallel transmittance)/(crossed transmittance)>11000 when a wavelength is 610 nm;
where parallel transmittance denotes optical transmittance of two polarizing plates arranged so that the polarizing axes become parallel to each other, and crossed transmittance denotes optical transmittance of two polarizing plates arranged so that the polarizing axes cross at right angles.

17. The method according to claim 13, wherein a luminous corrected transmittance Y is at least 42.5% when the standard illuminant is a C light source having luminous factor conrction per 10 nm in a range from 700 nm to 400 nm.

18. The method according to claim 16, wherein the transmittance Y is at least 43.0% but not more than 44.0%.

19. The method according to claim 13, wherein the polarization degree is at least 99.98%.
